(19) United States
(12) Patent Application Publication
(10) Pub. No.: US 2026/0205213 A1
(43) Pub. Date: Jul. 16, 2026

(54) PREDICTIVE MODEL FOR RECONFIGURATION OF PHASE CHANGE MATERIAL-BASED RECONFIGURABLE INTELLIGENT SURFACE

(71) Applicant: Dell Products L.P., Round Rock, TX (US)

(72) Inventors: Tejinder Singh, Manotick (CA); Navjot Kaur Khaira, Manotick (CA)

(21) Appl. No.: 19/023,264

(22) Filed: Jan. 15, 2025

(51) Int. Cl. H04B 17/336; H04B 17/24; H04B 17/318

(52) U.S. Cl. CPC H04B 17/336; H04B 17/24; H04B 17/318

(57) ABSTRACT

The technology described herein is directed towards phase-change material-based (e.g., chalcogenide) radio frequency components for use in the unit cells of a reconfigurable intelligent surface, and controlled to reconfigure the unit cells' operational characteristics based on user equipment location information. Artificial intelligence prediction based on user equipment location information preconfigures the patterns (per unit cell phase data) in anticipation of real-time reconfiguration, facilitating rapid reconfiguration of the reconfigurable intelligent surface, minimizing delays and enhancing overall system responsiveness and efficiency. The phase-change material determines the shape of the unit cells' resonating elements, and is real-time reconfigurable by the application of heat via a voltage pulse. By arranging the heating elements below the material, and actuating each one to provide resistive or conductive portions (e.g., widths) within the overall unit cell surface, an analog-like device is provided to provide more granular phase shift control of the cells of a reconfigurable intelligent surface.

### BACKGROUND

A reconfigurable intelligent surface includes an array of passive reflecting elements, each of which can independently impose a phase shift on the incoming signal. By adjusting the phase shifts of the reflecting elements, the reflected signals can be reconfigured to propagate towards their desired directions, and by selectively tuning the phase shifts of the reflecting elements, the reflected signals can be constructively superimposed to direct the signal power in a desired direction, including to constructively interfere to beamform the reflected signal or destructively combined for mitigating effects of multiuser interference.

### BRIEF DESCRIPTION OF THE DRAWINGS

The technology described herein is illustrated by way of example and not limited in the accompanying figures in which like reference numerals indicate similar elements and in which:

FIG. 1 is an exploded view representation of an example multi-layer structure of a model of a unit cell of a reconfigurable intelligent surface, in which reconfigurability is achieved by using a chalcogenide material layer, in accordance with various embodiments and implementations of the subject disclosure.

FIG. 2 shows an example of reversible switching of phase change material between an amorphous (high resistance) and crystalline (low resistance) states using a first electrical pulse for one state change and a second electrical pulse for a state change reversal, in accordance with various embodiments and implementations of the subject disclosure.

FIG. 3A shows an example of a unit cell surface for use in a reconfigurable intelligent surface with a controlled width that determines phase shift of the unit cell for redirecting an electromagnetic wave, in accordance with various embodiments and implementations of the subject disclosure.

FIG. 3B shows an example representation of the lower resistance and higher resistance portions of the unit cell surface of FIG. 3A, in accordance with various embodiments and implementations of the subject disclosure.

FIG. 4A shows an example of a unit cell surface for use in a reconfigurable intelligent surface with a controlled width, expanded relative to FIG. 3A, that determines phase shift of the unit cell for redirecting an electromagnetic wave, in accordance with various embodiments and implementations of the subject disclosure.

FIG. 4B shows an example representation of the lower resistance and higher resistance portions of the unit cell surface of FIG. 4A, in accordance with various embodiments and implementations of the subject disclosure.

FIG. 5 is an example graphical representation showing the tunability in phase shift of a reflected signal resulting from a controlled change in width of a phase change material lower resistance patch demonstrating a 27 GHz bandwidth in the U-Band that also covers sixty percent of the V-Band, in accordance with various embodiments and implementations of the subject disclosure.

FIG. 6 is an example graphical representation showing the magnitude change of |S₂₁| highlighting the tunability in resonance frequency within the U-Band and sixty percent of the V-Band U-band (40-60 GHz) with a 27 GHz bandwidth.

FIG. 7 is a representation of an example overall reconfigurable intelligent surface system showing the direction of a reflected beam being controlled by a configuration provided by a field programmable gate array, in accordance with various embodiments and implementations of the subject disclosure.

FIG. 8 is a sequence diagram of example operations of artificial intelligence (AI)-based reconfiguration of phase change elements in a reconfigurable intelligent surface, in accordance with various embodiments and implementations of the subject disclosure.

FIG. 9 is a state diagram representing an example process and components related to dynamically reconfiguring a reconfigurable intelligent surface based on user equipment location information using AI models, in accordance with various embodiments and implementations of the subject disclosure.

FIG. 10 is a flow diagram showing example operations related to determining configuration data using a trained model, to configure a reconfigurable intelligent surface based on user equipment location information, to the controller for use in configuration of the reconfigurable intelligent surface, in accordance with various embodiments and implementations of the subject disclosure.

FIG. 11 is a flow diagram showing example operations related to obtaining prediction data from a trained model to control phase shift data of unit cells based on user location information, in accordance with various embodiments and implementations of the subject disclosure.

### DETAILED DESCRIPTION

As mentioned in the background, by adjusting the phase shifts of reflecting elements of a reconfigurable intelligent surface, the reflected signals can be reconfigured to propagate towards their desired directions. Traditionally, this reconfiguration has been achieved using PIN diodes or varactors. However PIN diodes or varactors present significant limitations, such as a relatively limited number of reconfigurable states that can be achieved, and significant complexity in biasing hundreds of these components, leading to intricate wiring behind the reconfigurable intelligent surface panel.

In consideration of these and other issues with conventional techniques, various implementations and embodiments of the technology described herein are generally directed towards a phase change material-based device that can be used in a unit cell of a reconfigurable intelligent surface. In general, the phase change material of each unit cell can be configured as a resonator having different conductive portions (e.g., conductive widths) relative to non-conductive portions. The relative conductive portion (or portions) of a unit cell determine the phase shift of the unit cell.

The conductive portion/shape of such resonating elements is real-time reconfigurable by the application of heat, which is provided in the form of a voltage pulse via a network of individual heating elements at the unit cell level. However, while reconfigurable, generating and providing these pulses in real-time introduces delays that can affect performance. Described herein is leveraging trained model (e.g., artificial intelligence/AI-based) prediction techniques based on user equipment location information, which facilitates preconfiguring of the patterns in anticipation of real-time changes. In general and as will be understood, the trained model prepares the reconfigurable intelligent surface for rapid reconfiguration, minimizing delays and enhancing overall system responsiveness and efficiency.

It should be understood that any of the examples herein are non-limiting. As one example, a unit cell of a reconfigurable intelligent surface is described that is based on switching elements made of chalcogenide materials, e.g., alloys based on germanium-antimony-tellurium (GeSbTe); however this is only one non-limiting example, and other materials, including those not yet developed, can be leveraged by the technology described herein. Thus, any of the embodiments, aspects, concepts, structures, functionalities or examples described herein are non-limiting, and the technology may be used in various ways that provide benefits and advantages in communications and reconfigurable intelligent surfaces in general. It also should be noted that terms used herein, such as “optimize” or “optimal” and the like only represent objectives to move towards a more optimal state, rather than necessarily obtaining ideal results.

Reference throughout this specification to “one embodiment,” “an embodiment,” “one implementation,” “an implementation,” etc. means that a particular feature, structure, or characteristic described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. Repetitive description of like elements employed in respective embodiments may be omitted for sake of brevity.

The following detailed description is merely illustrative and is not intended to limit embodiments and/or application or uses of embodiments. Furthermore, there is no intention to be bound by any expressed or implied information presented in the preceding sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Further, it is to be understood that the present disclosure will be described in terms of a given illustrative architecture; however, other architectures, structures, substrate materials and process features, and steps can be varied within the scope of the present disclosure.

It will also be understood that when an element such as a layer, region or substrate is referred to as being “on” or “over” another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

Aspects of the subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

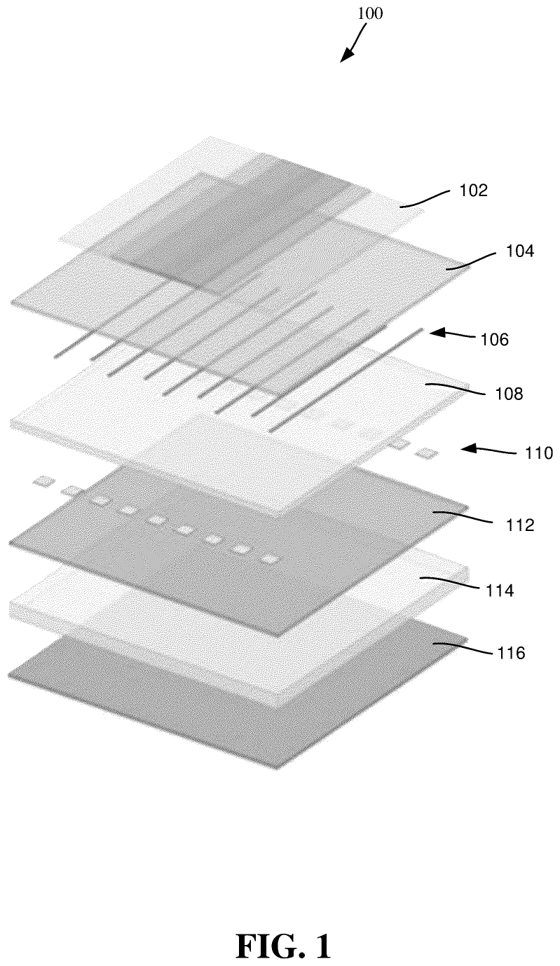

FIG. 1 shows an example multi-layer structure 100 of a unit-cell, including a topmost, uniform layer 102 of a phase change material (e.g., GST alloy, made from reconfigurable chalcogenide). Moving downward in the representation of FIG. 1, the next lower (second) layer is a thermally conductive layer 104. A heater network 106 (e.g., refractory heater) is formed on third layer, which in this example includes separate heating elements, followed by a layer of thermally insulator material 108. The thermally conductive layer 104 on the top of heater network 106 allows the applied heat to conduct to the GST alloy, while the thermal insulator material 108 below the heater network prevents the heat flow downwards.

The control/bias network 110 for the heaters is designed on fifth layer, followed by a dielectric layer 112, which is coated on a high permittivity substrate 114. The bottom of the substrate is coated by another thin metallization layer 116. The heating elements can be individually controlled as described herein.

Chalcogenide material is formed with alloys containing group VI elements such as sulfur(S), selenium (Se) and telluride (Te). Among these, the alloys formed from different ratio combinations of germanium, antimony, and telluride (Ge—Sb—Te, or GST alloys) are currently the most popular for radio frequency and optical memory applications. In general, single-phase alloys are made of germanium telluride (GeTe) and antimony telluride (Sb2Te3). Alloys include Ge1Sb2Te4, Ge2Sb2Te5, and Ge1Sb4Te7. Depending on the alloy used, the properties range from high stability and low speed to low stability and high speed. The GST alloys have a unique property of reversibly switching between amorphous and crystalline states upon specific heat treatment by means of electrical pulses, hence the name “phase-change.” The state in which atoms are arranged in a disorderly manner (short range order) is called the amorphous state, whereas the state where atoms are organized in an orderly manner (long range order) is called crystalline state. The disordered amorphous state has a lower mean free path of conduction for electrons that impedes current flow due to electron scattering, thus resulting in a higher resistance when compared to the crystalline state.

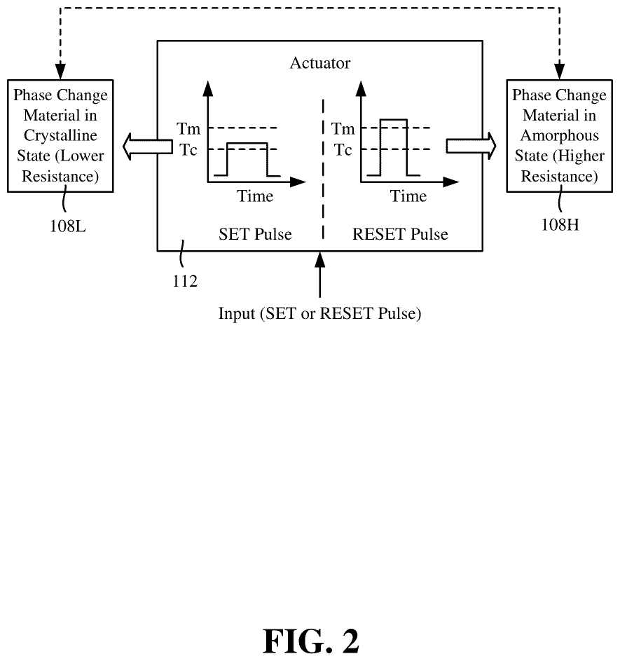

The operation principle of the example unit cell structure 100 of FIG. 1 is based on the many orders of magnitude resistance change that chalcogenide phase change GST alloys undergo when provided a specific heat treatment using a pulse, as described with reference to FIG. 2. Such materials can reversibly transition between a low resistance (metallic/conductive) state to a high resistance (insulator/resistive) state. This transition occurs due to the change in crystal structure of the alloy, which changes from amorphous to crystalline. In order to control the states of the material, the heater network 106 has a matrix of heaters (heating elements) placed below the phase change material (chalcogenide material) layer 102. The narrow-width heating elements can be individually actuated by an electronic pulse. In the absence of any actuation, the material is in its amorphous (high resistance) state and acts as an insulator. A limited area (portion) of the chalcogenide material 102 is actuated by each heating element, and as more and more heaters are actuated, a larger and larger area of the material transitions to the low resistance metal state. Hence, a dynamic change in the shape of the reflection surface, which can correspond to its capacitance (area of the topmost conductor) can be achieved at a high speed, which provides the ultrafast reconfigurable operation.

Turning to tuning the unit cells'individual phases, in one example implementation the respective unit cells can be based on the effective operational width of the respective chalcogenide elements such as described in the examples herein. As shown in FIG. 2, a medium amplitude and relatively longer duration (typically on the order of 400 nanoseconds) SET electrical pulse (e.g., represented in the left portion of the actuator) is used for crystallization during a transition to the ON state. Energy from the SET pulse heats the material for sufficient time to crystallize the material and provides adequate time for atoms to reorganize to an orderly arrangement, thus transforming from an amorphous state to a crystalline (conductive) state. To change to the amorphous state, a short duration (typically less than 400 nanoseconds) and high amplitude (typically >2 V) RESET electrical pulse is used. The RESET pulse provides sufficient energy to melt the material to disorder the atoms followed by rapid quenching to freeze the atoms, thus transforming the material from the crystalline state to the amorphous (nonconductive) state. Only a short duration pulse to a heating element is implicated to switch the state of the material 102 (FIG. 1) between states at the area/portion above the corresponding heating element; of note, the pulse transforms the material and latches the material into the state, without the need for continuous power in either state. The pulse duration and amplitude can be further optimized by tuning the ratio of GeSbTe alloy ratios.

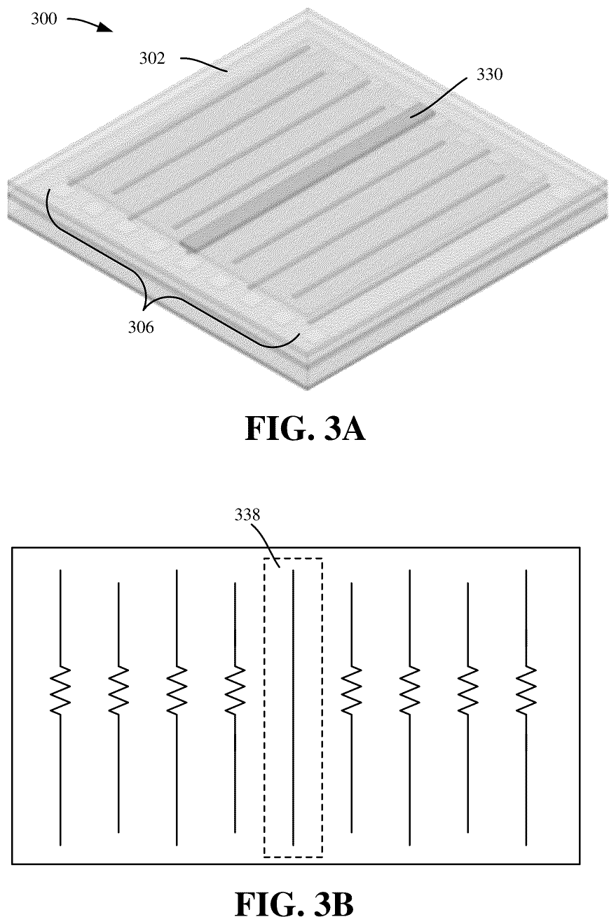

FIG. 3A shows a device 300 configured to have a relatively narrow width of conductive material 330 obtained by pulsing (as needed) the corresponding heating element(s) below the chalcogenide material 302 to create the appropriate higher or lower resistance states. FIG. 3B conceptually shows the example resistive and conductive states corresponding to FIG. 3A after actuation of the heater elements to obtain these states. The dashed box 338 generally represents the conductive area.

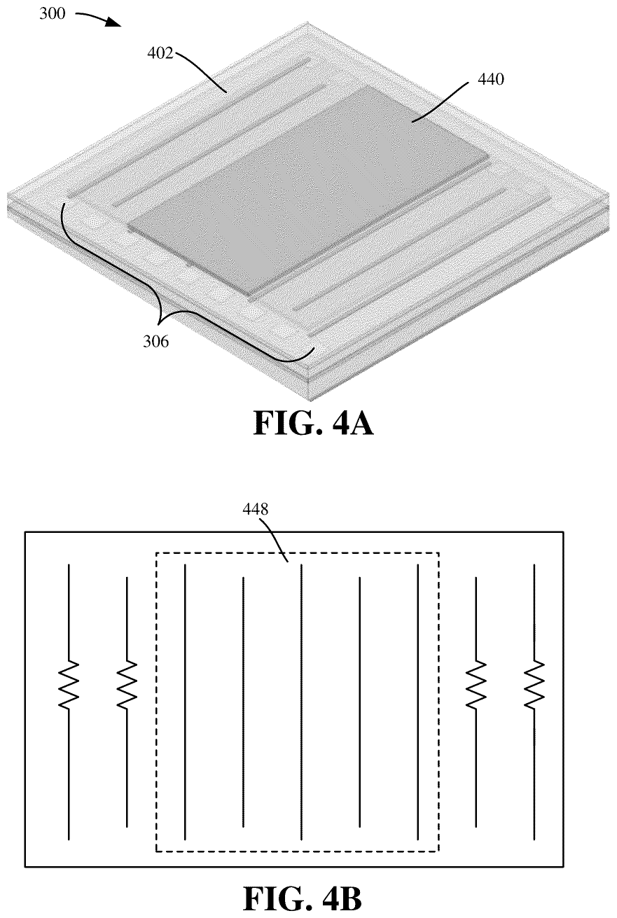

FIG. 4A shows a wider operational width 440 (relative to FIG. 3A) of the device 300 obtained by controlling the heater network 306 to enlarge the conductive portion of the chalcogenide material 302 to create the appropriate higher or lower resistance states. In this example, the conductive portions are a contiguous group, while the two resistive portions are discontiguous subgroups of the resistive areas. FIG. 4B conceptually shows the example resistive and conductive states corresponding to FIG. 4A after actuation of the heater elements to obtain these states. The dashed box 448 generally represents the conductive area.

Note that there can be discontiguous subgroups of conductive areas. Further, it should be noted that the heating elements of the heater network 106 can be, but need not be, symmetrical or substantially symmetrical with respect to their separation distances. Still further, the heating elements can be, but need not be, the same widths or substantially the same widths, nor need they necessarily be parallel or substantially parallel to one another.

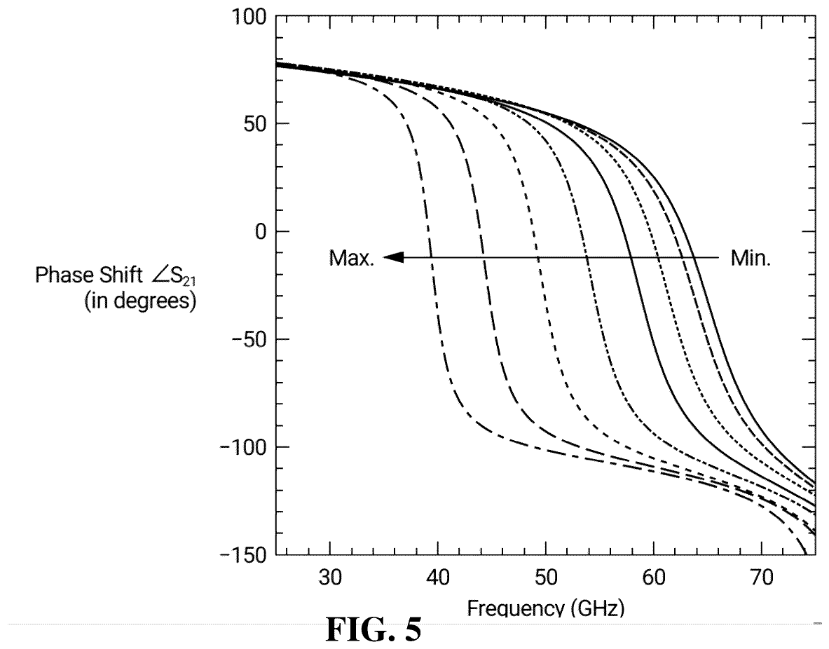

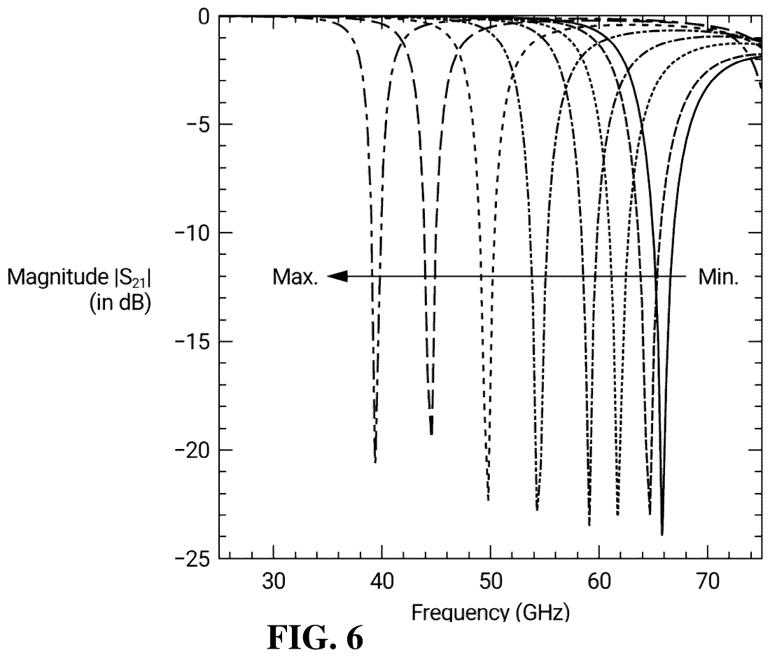

The device performance can be simulated using full-wave 3D electromagnetic (EM) simulation software, and the phase shift offered to the reflected signal can be evaluated for a discrete set of widths, which can be electronically controlled. One example unit-cell was designed for operation around 50 GHz, with an extremely large 27 GHz bandwidth. The relative phase shift offered to the reflected signal from the unit-cell is graphically represented in FIG. 5, with various widths of the conductive patch ranging from a minimum area to a maximum area with respect to the reduction/expansion of the conductive area. In one embodiment, each heater element can actuate an area of 0.1 mm; hence, the simulations were performed with a step size of 0.1 mm in width. The phase shift offered to the reflected electromagnetic signal from the unit cell can be tuned by changing the width of the conductive patch as displayed in the simulated performance in FIG. 5. The corresponding shift in the resonance in magnitude of |S₂₁| is represented in FIG. 6, demonstrating 27 GHz bandwidth over the U-Band and spanning towards the V-Band.

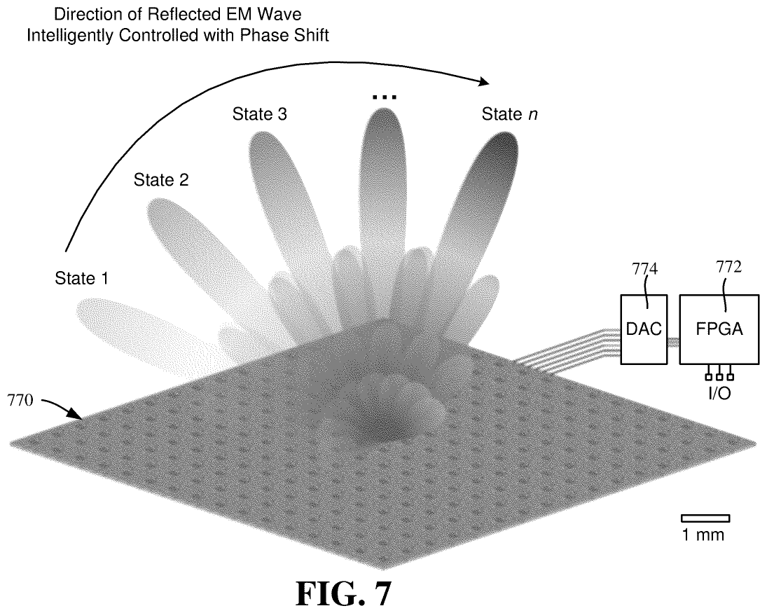

A reconfigurable intelligent surface can be formed by arranging multiple unit cells in a two-dimensional m×n array, e.g., as shown in the surface 770 of FIG. 7. In general, a reconfigurable intelligent surface is a planar surface built from an array of passive reflecting (or refracting) elements, each of which can independently impose a desired phase shift on the incoming signal. By adjusting the phase shifts of the reflecting elements, reflected signals can be reconfigured to propagate towards their desired directions. As described herein, the reflection coefficients of each element can be reconfigured in real-time to adapt to the dynamically fluctuating wireless propagation environment. By appropriately tuning the phase shifts of the reflecting elements of the reconfigurable intelligent surface, the reflected signals can be constructively superimposed with those from the direct paths for enhancing the desired signal power, or destructively combined for mitigating deleterious effects of multiuser interference. Hence, reconfigurable intelligent surfaces provide additional degrees of freedom to further improve the system performance. In the outdoors, a reconfigurable intelligent surface can be applied to buildings, windows and so forth to enhance the signal in dead or weak zones and strengthen the signal in already covered areas. A reconfigurable intelligent surface can also be deployed for spatial microwave modulation in a typical office room and can passively increase the received signal power by an order of magnitude, or completely null it. Furthermore, a reconfigurable intelligent surface naturally operates in full-duplex (FD) mode without self-interference or introducing thermal noise. Therefore, reconfigurable intelligent surfaces achieve higher spectral efficiency than active half-duplex (HD) relays, despite their lower signal processing complexity relative to that of active full duplex relays requiring sophisticated self-interference cancellation.

Thus, as shown in FIG. 7, a reconfigurable intelligent surface 770 formed from an array of unit cells is able to vary the direction of a reflected beam/electromagnetic wave based on intelligently controlling the phase shifts of the unit cells, in this example via a field-programmable gate array. With respect to configuring the array digitally, in this example, a field-programmable gate array (e.g., controller) 772 is used to provide the output, mapped to the heating elements of the cells and converted (DAC 774) to the appropriate RESET or SET pulses based on the zero-or one-bit pattern instruction as applicable, to each heating element of each cell of the array of cells as applicable to change state. The output gives instructions to the individual heating/switching elements of the individual unit cells, independent from each other switching element, and thereby sets the cell's phase shift independent from each other cell. In other words, actively tuning the phase change material-in each cell can be individually controlled by the field-programmable gate array 772, which provides a coding output of 0s and 1s.

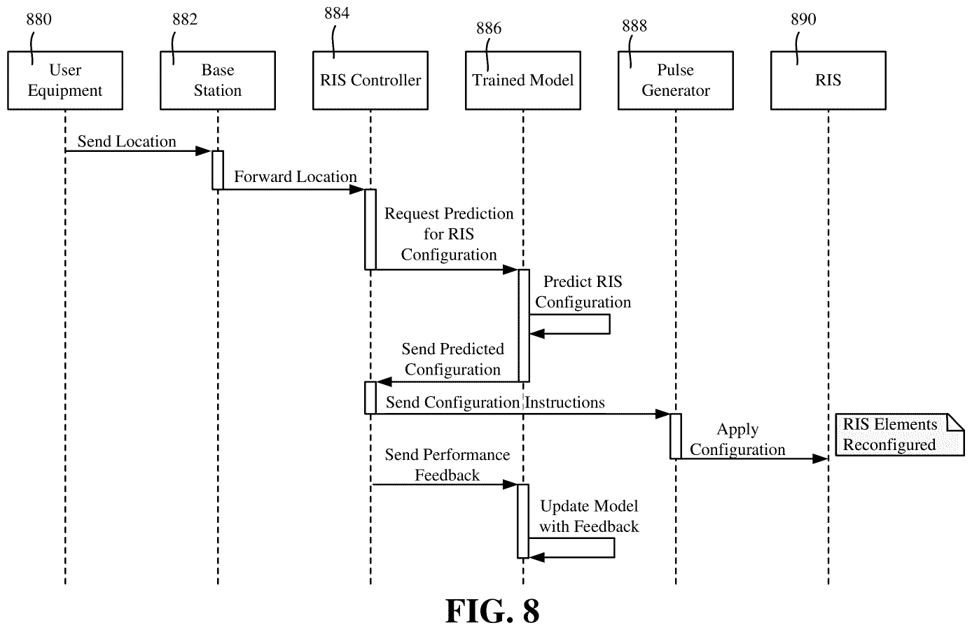

The sequence diagram in FIG. 8 illustrates an example process of reconfiguring a reconfigurable intelligent surface based on the location of a UE. Components/entities shown in FIG. 8 include a user equipment (UE) 880, base station 882, reconfigurable intelligent surface controller 884, trained (AI) model 886, pulse generator 888, and the reconfigurable intelligent surface (RIS) 890.

The example sequence begins with the UE 880 sending its location information to the base station 882, which then forwards this information to the reconfigurable intelligent surface controller 884. The reconfigurable intelligent surface controller 884 requests a prediction for an optimal reconfigurable intelligent surface configuration from the AI model 886, which processes the request and sends back predicted configuration data. Using the predicted configuration data, the reconfigurable intelligent surface controller 886 subsequently sends configuration instructions to the pulse generator 888, which via pulses applies the new configuration to the elements of the reconfigurable intelligent surface 890, thereby reconfiguring the phase shifts of the unit cells.

After the RIS elements are reconfigured, the RIS controller sends performance feedback back to the AI model. This feedback allows the AI model to update and improve its prediction process for future reconfigurations.

It should be noted that multiple UE devices can be tracked with respect to their respective locations, whereby the RIS can be reconfigured to communicate with (redirect signals to and from) the multiple UEs. For example, instead of or in addition to steering a beam, a RIS can be reconfigured to widen the beam to increase its coverage area (at the expense of reduced signal strength), in the event multiple UE devices start to separate from one another.

Because a typical RIS is equipped with only a small microcontroller with limited memory and compute power, lightweight AI models like Decision Trees and k-Nearest Neighbors (k-NN) can be used. Decision Trees are efficient in terms of memory and computation, making fast and easy-to-interpret predictions based on a series of if-then rules. The model can be trained on historical data of UE locations and corresponding RIS configurations and then implemented in the microcontroller's firmware as a series of nested if-then-else statements for real-time predictions. Once trained, decision trees can make predictions very quickly, which is crucial for real-time applications.

A k-NN model/process is straightforward and instance-based, requiring no complex training phase. The NN model predicts the optimal RIS configuration by identifying the more similar instances (neighbors) in the stored dataset based on UE location and environmental conditions. The k-NN model's flexibility and ease of adaptation make it practical for real-time applications, where the microcontroller can quickly compute the distances to stored instances and select the most appropriate RIS configuration based on the nearest neighbors.

Both models provide efficient and effective solutions for dynamically reconfiguring the RIS on resource-constrained microcontrollers.

To summarize, a reconfigurable intelligent surface acts as a passive repeater between the base station and user equipment (UEs), (although some array gain can be achieved by focusing a relatively narrow redirected beam to a target). When a UE moves, the reconfigurable intelligent surface, based on phase change material patches, can be reconfigured to more accurately beam steer in the direction of the UE, based on the UE's location information being processed by a trained AI model. Reconfiguration of the reconfigurable intelligent surface results receives information about the from the base station resulting from the phase change material-based reconfigurable intelligent surface panel being connected to a reconfigurable intelligent surface controller that includes a pulse generating module.

Note that there is always some delay in determining the UE's location and generating the pulses from the pulse generator to simultaneously reconfigure the reconfigurable intelligent surface elements throughout the reconfigurable intelligent surface panel. During this delay, the intermediate states result in signal distortion. The pulse generators take time to produce the SET or RESET pulses for the phase change material patches that function as reconfigurable intelligent surface elements. Although the phase change material itself can switch between amorphous and crystalline states in nanoseconds, the bottleneck lies in generating the appropriate pulses from the pulse generator. Therefore, utilizing AI to predict the next configuration based on the learned patterns of the UE's movement is beneficial, because AI prediction allows the system to provide an early head start to the pulse generator, preparing the pulse generator for the upcoming configuration based on the UE location information, thereby minimizing delay, and reducing signal distortion.

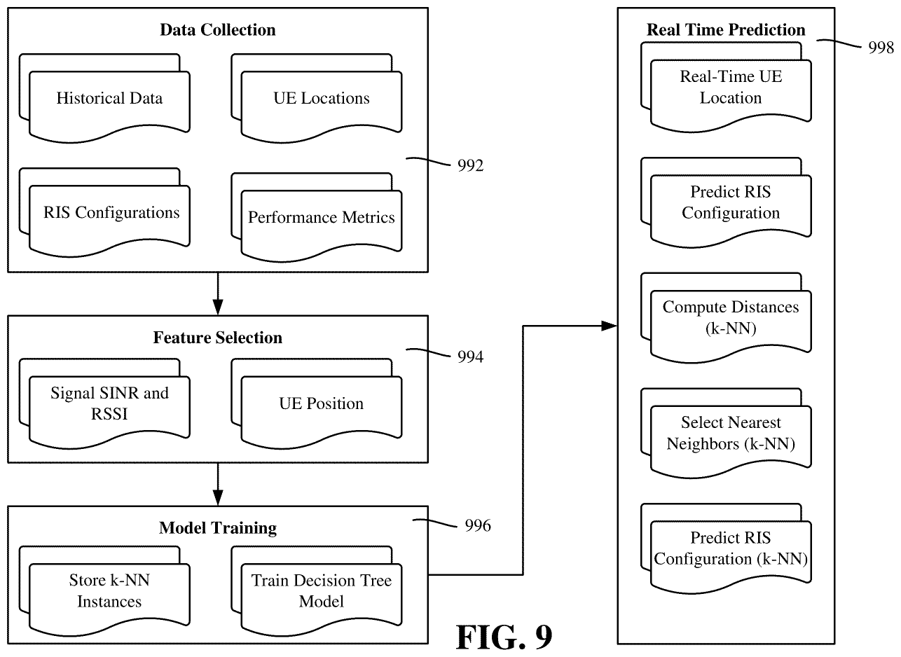

The state diagram in FIG. 9 for dynamic reconfigurable intelligent surface reconfiguration using AI models illustrates the sequential process starting from data collection to real-time prediction. Initially, the system enters the data collection state (block 992), where historical data such as UE locations, reconfigurable intelligent surface configurations, and performance metrics are gathered. This data then transitions the system into the feature selection state, (block 994), where certain features including (but not limited to) UE position and signal SINR and RSSI are identified to aid in model training. Following this, the system moves to the model training state (block 996), in which AI models, e.g., Decision Tree and k-NN, are trained using the collected data and selected features.

Once the AI models are trained, the system waits in the real-time prediction state (block 998) for real-time UE location data. Upon receiving this data, the AI models predict the optimal reconfigurable intelligent surface configuration, which is then applied as described herein. note that an extension to this state diagram can include monitoring the performance, where the effectiveness of the reconfigurable intelligent surface configuration is evaluated by monitoring signal strength and direction. Such performance data can be fed back into the AI model for continuous improvement/occasional retraining.

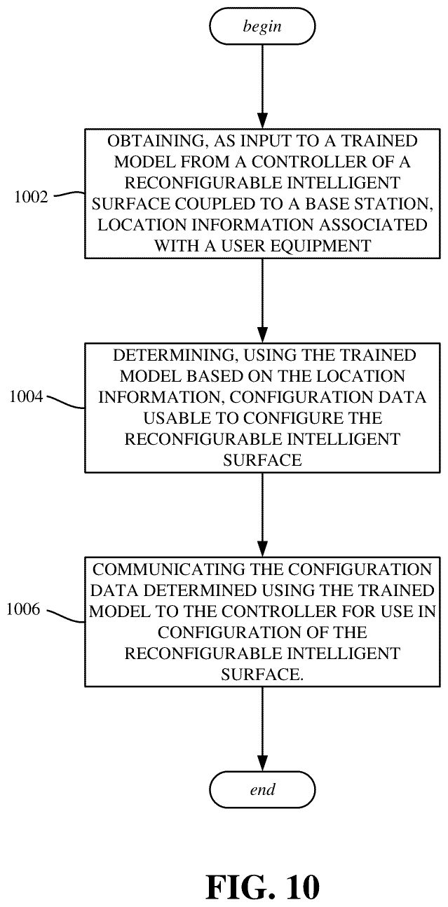

One or more implementations can be embodied in a system, such as represented in the example operations of FIG. 10, and for example can include at least one processor memory that stores computer executable components and/or operations, and at least one processor that executes computer executable components and/or operations stored in the memory. Example operations can include operation 1002, which represents obtaining, as input to a trained model from a controller of a reconfigurable intelligent surface coupled to a base station, location information associated with a user equipment. Example operation 1004 represents determining, using the trained model based on the location information, configuration data usable to configure the reconfigurable intelligent surface. Example operation 1006 represents communicating the configuration data determined using the trained model to the controller for use in configuration of the reconfigurable intelligent surface.

Determining the configuration data can include determining respective conductive portion dimension data of respective unit cells of the reconfigurable intelligent surface.

Determining the configuration data can include determining conductive portion dimension data representative of a conductive portion of a unit cell of the reconfigurable intelligent surface. The conductive portion dimension data representative of the conductive portion can correspond to a width dimension of variable-width conductive material. The conductive material can include chalcogenide material that can be energy-pulsed by a heater network to determine first dimension data of one or more conductive portions of the chalcogenide material on the unit cell, and second dimension data of one or more nonconductive portions of the chalcogenide material on the unit cell.

The location information can be first location information, the configuration data can be first configuration data, and wherein the further operations can include obtaining, as further input to the trained model from the controller, second location information associated with the user equipment, determining, using the trained model based on the second location information, second configuration data usable to configure the reconfigurable intelligent surface, and returning the second configuration data determined using the trained model to the controller for use in reconfiguration of the reconfigurable intelligent surface.

Further operations can include obtaining, as further input to the trained model from the controller, performance feedback data corresponding to communication between the base station and the user equipment, and updating the trained model based on the performance feedback data.

The performance feedback data can include at least one of: signal-to-interference-plus-noise ratio data representative of a signal-to-interference-plus-noise ratio corresponding to the communication between the base station and the user equipment, or received signal strength indicator data representative of a received signal strength indicator corresponding to the communication between the base station and the user equipment.

Obtaining the location information associated with the user equipment can include receiving a request for a prediction of the configuration data, the request including or associated with the location information.

The user equipment can be part of a group of devices, and the location information can include per-device location data for at least a subgroup of the group of devices.

The trained model can be coupled to or incorporated into the controller.

The trained model can include a decision tree model.

The trained model can include a k-nearest neighbor model.

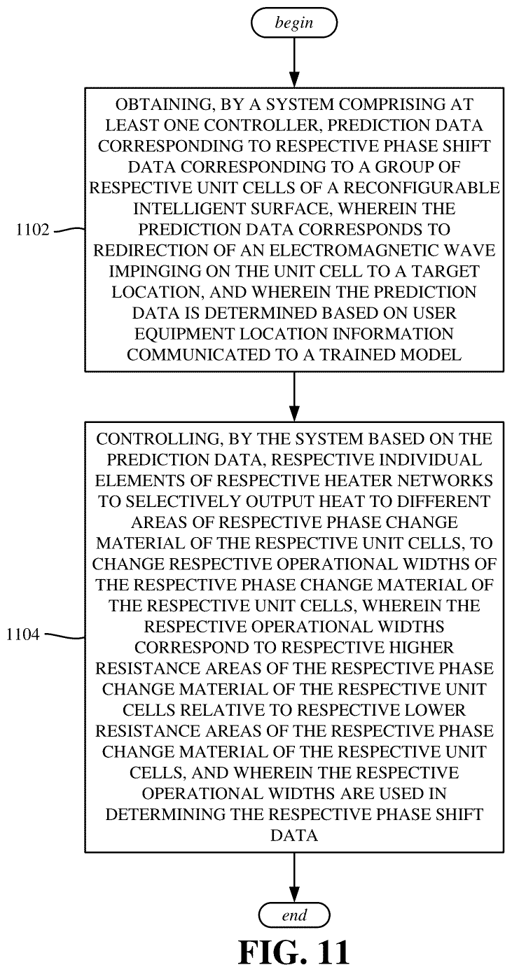

One or more example embodiments and/or implementations, such as corresponding to example operations of a method, can be represented in FIG. 11. Example operation 1102 represents obtaining, by a system including at least one controller, prediction data corresponding to respective phase shift data corresponding to a group of respective unit cells of a reconfigurable intelligent surface, in which the prediction data corresponds to redirection of an electromagnetic wave impinging on the unit cell to a target location, and the prediction data can be determined based on user equipment location information communicated to a trained model. Example operation 1104 represents controlling, by the system based on the prediction data, respective individual elements of respective heater networks to selectively output heat to different areas of respective phase change material of the respective unit cells, to change respective operational widths of the respective phase change material of the respective unit cells, in which the respective operational widths correspond to respective higher resistance areas of the respective phase change material of the respective unit cells relative to respective lower resistance areas of the respective phase change material of the respective unit cells, and the respective operational widths are used in determining respective operational characteristics of the respective unit cells, (e.g., respective phase shift data, operational frequency band data, and so on).

Controlling the respective individual elements of the respective heater networks can include pulsing the respective individual elements of the respective heater networks to set respective portions of the respective phase change material to the respective higher resistance areas or to the respective lower resistance areas.

Further operations can include obtaining, by the system, performance feedback data usable to update the trained model based on communications via the reconfigurable intelligent surface following the controlling of the respective individual elements based on the prediction data, and communicating, by the system, the performance feedback data to the trained model.

Obtaining the performance feedback data can include determining the performance feedback data based on at least one of: signal-to-interference-plus-noise ratio data or received signal strength indicator data.

One or more implementations can be embodied in a system, including a controller coupled to a reconfigurable intelligent surface. The controller can be configured to obtain location information applicable to at least one location of a user equipment, obtain, from a trained model based on the location information, prediction data usable to configure the reconfigurable intelligent surface; and control a pulse generator to configure the reconfigurable intelligent surface based on the prediction data.

The controller can be further configured to obtain performance feedback data representative of communications between a base station and the user equipment via the reconfigurable intelligent surface as configured by the prediction data, and facilitate an update to the trained model based on the performance feedback data.

The controller can control the pulse generator to configure respective operational widths of at least some respective unit cells of the reconfigurable intelligent surface based on the prediction data, and the respective operational widths can determine at least one of: respective phase shift data of the respective unit cells, or an operational frequency band of the respective unit cells.

As can be seen, the technology described herein can achieve a wide range of analog-like RIS reconfiguration in real-time using GST alloy patterns, (unlike PIN diodes or varactors that provide limited reconfigurable states). The RIS can be dynamically reconfigured to operate across different frequency bands without the need for physical redesign or refabrication, with such flexibility achieved by altering the shape and/or size of the RIS elements, with larger patterns resonating at lower frequencies and smaller patterns resonating at higher frequencies. Utilizing phase change materials, the RIS element patterns can be modified dynamically to adjust to different operational frequencies, a capability that significantly surpasses traditional methods that require a complete redesign and fabrication for each new frequency band. The material patches' dimensions can be dynamically adjusted, enabling rapid and efficient phase shift changes and/or frequency band switching, providing significant adaptability and efficiency in optimizing communication performance.

The AI-based predictive adaptation described herein facilitate real-time prediction and adaptation of RIS configurations based on the dynamic location data of UEs. This predictive capability minimizes latency and optimizes signal directionality, enhancing communication efficiency.

The phase change material's state locking functionality offers a low power advantage, in that the GST alloys can lock into a conductive or nonconductive state (either crystallization or amorphous state) and maintain their properties while drawing no further power. This is a significant power advantage over other RIS topologies that use lumped components like PIN diodes, varactors, etc. that consume power when operated for extended periods of time.

The phase change material facilitates extremely fast switching for real-time beam readjustment, given that the switching time between two states is in nanoseconds. The RIS described herein thus provides the real-time reconfiguration capabilities usable to fit the immediate demands presented by a dynamic environment.

In sum, the use of proven AI processes, such as Decision Trees or k-NN, ensures the system's capability to handle dynamic reconfiguration effectively. The fast-switching properties of phase change materials make them suitable for rapid and precise reconfiguration of RIS elements. The system can be integrated with existing base stations and UEs, making it a viable upgrade rather than having to perform a complete overhaul of current infrastructure. Reducing the need for physical redesigns and utilizing efficient AI models lowers the overall cost of implementation and maintenance. By leveraging AI for real-time reconfiguration, technology described herein provides a highly adaptable, efficient, and cost-effective solution for optimizing RIS performance in modern communication networks.

What has been described above include mere examples. It is, of course, not possible to describe every conceivable combination of components, materials or the like for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
at least one processor; and
at least one memory that stores executable instructions that, when executed by the at least one processor, facilitate performance of operations, the operations comprising:
obtaining, as input to a trained model from a controller of a reconfigurable intelligent surface coupled to a base station, location information associated with a user equipment;
determining, using the trained model based on the location information, configuration data usable to configure the reconfigurable intelligent surface; and
communicating the configuration data determined using the trained model to the controller for use in configuration of the reconfigurable intelligent surface.

2. The system of claim 1, wherein the determining of the configuration data comprises determining respective conductive portion dimension data of respective unit cells of the reconfigurable intelligent surface.

3. The system of claim 1, wherein the determining of the configuration data comprises determining conductive portion dimension data representative of a conductive portion of a unit cell of the reconfigurable intelligent surface.

4. The system of claim 3, wherein the conductive portion dimension data representative of the conductive portion corresponds to a width dimension of variable-width conductive material.

5. The system of claim 4, wherein the conductive material comprises chalcogenide material that is energy-pulsed by a heater network to determine first dimension data of one or more conductive portions of the chalcogenide material on the unit cell, and second dimension data of one or more nonconductive portions of the chalcogenide material on the unit cell.

6. The system of claim 1, wherein the location information is first location information, wherein the configuration data is first configuration data, and wherein the operations further comprise obtaining, as further input to the trained model from the controller, second location information associated with the user equipment, determining, using the trained model based on the second location information, second configuration data usable to configure the reconfigurable intelligent surface, and returning the second configuration data determined using the trained model to the controller for use in reconfiguration of the reconfigurable intelligent surface.

7. The system of claim 1, wherein the operations further comprise obtaining, as further input to the trained model from the controller, performance feedback data corresponding to communication between the base station and the user equipment, and updating the trained model based on the performance feedback data.

8. The system of claim 7, wherein the performance feedback data comprises at least one of: signal-to-interference-plus-noise ratio data representative of a signal-to-interference-plus-noise ratio corresponding to the communication between the base station and the user equipment, or received signal strength indicator data representative of a received signal strength indicator corresponding to the communication between the base station and the user equipment.

9. The system of claim 1, wherein the obtaining of the location information associated with the user equipment comprises receiving a request for a prediction of the configuration data, the request comprising the location information.

10. The system of claim 1, wherein the user equipment is part of a group of devices, and wherein the location information comprises per-device location data for at least a subgroup of the group of devices.

11. The system of claim 1, wherein the trained model is coupled to or incorporated into the controller.

12. The system of claim 1, wherein the trained model comprises a decision tree model.

13. The system of claim 1, wherein the trained model comprises a k-nearest neighbor model.

14. A method, comprising,
obtaining, by a system comprising at least one controller, prediction data corresponding to respective phase shift data corresponding to a group of respective unit cells of a reconfigurable intelligent surface, wherein the prediction data corresponds to redirection of an electromagnetic wave impinging on the unit cell to a target location, and wherein the prediction data is determined based on user equipment location information communicated to a trained model; and
controlling, by the system based on the prediction data, respective individual elements of respective heater networks to selectively output heat to different areas of respective phase change material of the respective unit cells, to change respective operational widths of the respective phase change material of the respective unit cells, wherein the respective operational widths correspond to respective higher resistance areas of the respective phase change material of the respective unit cells relative to respective lower resistance areas of the respective phase change material of the respective unit cells, and wherein the respective operational widths are used in determining respective operational characteristics of the respective unit cells.

15. The method of claim 14, wherein the controlling of the respective individual elements of the respective heater networks comprises pulsing the respective individual elements of the respective heater networks to set respective portions of the respective phase change material to the respective higher resistance areas or to the respective lower resistance areas.

16. The method of claim 14, further comprising obtaining, by the system, performance feedback data usable to update the trained model based on communications via the reconfigurable intelligent surface following the controlling of the respective individual elements based on the prediction data, and communicating, by the system, the performance feedback data to the trained model.

17. The method of claim 16, wherein the obtaining of the performance feedback data comprises determining the performance feedback data based on at least one of: signal-to-interference-plus-noise ratio data or received signal strength indicator data.

18. A system, comprising:
a controller coupled to a reconfigurable intelligent surface, wherein the controller is configured to:
obtain location information applicable to at least one location of a user equipment;
obtain, from a trained model based on the location information, prediction data usable to configure the reconfigurable intelligent surface; and
control a pulse generator to configure the reconfigurable intelligent surface based on the prediction data.

19. The system of claim 18, wherein the controller is further configured to obtain performance feedback data representative of communications between a base station and the user equipment via the reconfigurable intelligent surface as configured by the prediction data, and facilitate an update to the trained model based on the performance feedback data.

20. The system of claim 18, wherein the controller controls the pulse generator to configure respective operational widths of at least some respective unit cells of the reconfigurable intelligent surface based on the prediction data, and wherein the respective operational widths determine at least one of: respective phase shift data of the respective unit cells, or an operational frequency band of the respective unit cells.
